(19) United States
(12) Patent Application Publication
(10) Pub. No.: US 2025/0141158 A1
(43) Pub. Date: May 1, 2025

(54) ELECTRICAL CONNECTOR

(71) Applicant: MOLEX, LLC, Lisle, IL (US)

(72) Inventor: Yun-Fang Yang, Pudong Shanghai (CN)

(21) Appl. No.: 18/915,364

(22) Filed: Oct. 15, 2024

(30) Foreign Application Priority Data
Oct. 31, 2023 (CN) 202311434094.9

(51) Int. Cl. H01R 13/6585; H01R 13/6477

(52) U.S. Cl. CPC H01R 13/6585; H01R 13/6477

(57) ABSTRACT

An electrical connector is provided, the electrical connector includes: a shell; an insulative body mounted inside the shell, the insulative body includes a base and a tongue which extends from the base along a first direction; a plurality of first conductive terminals fixed to the insulative body and partially exposed to a first mating surface of the tongue, a contacting region of the first high frequency signal conductive terminal and a contacting region of the adjacent first conductive terminal are provided therebetween with a first impedance adjusting portion; a plurality of second conductive terminals fixed to insulative body and partially exposed to a second mating surface of the tongue, a contacting region of the second high frequency signal conductive terminal and a contacting region of the adjacent second conductive terminal are provided therebetween with a second impedance adjusting portion; and a middle isolating plate, a position of the middle isolating plate which corresponds to the high frequency signal conductive terminals is provided with a signal shielding portion. The electrical connector is beneficial to promote high frequency transmission effect, is simple in structure, and is convenient to be assembled.

### TECHNICAL FIELD

The present disclosure relates to technical field of electronic devices, and specifically relates to an electrical connector.

### BACKGROUND

An existing electrical connector generally includes a metal shell and an insulative body, a middle isolating plate, an internal shielding shell and conductive terminals fixed on the insulative body which are mounted in the metal shell, at the same time in order to realize high frequency transmission, the conductive terminals are provided with a high frequency signal conductive terminal therein.

In a process of data transmission, there is interference and crosstalk with a high frequency signal at different extents, at present the affect on the signal is mainly reduced by providing the middle isolating plate, the internal shielding shell or the metal shell. As the requirement on data transmission speed is higher, higher requirement on characteristic impedance in a process of high frequency transmission is proposed.

### SUMMARY

In connection with the problem in the existing technology, an object of the present disclosure is to provide an electrical connector which promotes high frequency transmission effect, is simple in structure, and is convenient to be assembled.

An embodiment of the present disclosure provides an electrical connector comprising: a shell; an insulative body mounted inside the shell, the insulative body comprises a base and a tongue which extends from the base along a first direction, the tongue comprises a first mating surface and a second mating surface which are oppositely provided along a second direction, and the shell encircles the tongue to form a mating cavity; a plurality of first conductive terminals fixed to the insulative body and partially exposed to the first mating surface, the plurality of first conductive terminals comprise at least one first high frequency signal conductive terminal, a contacting region of the first high frequency signal conductive terminal and a contacting region of the adjacent first conductive terminal are provided therebetween with a first impedance adjusting portion; a plurality of second conductive terminals fixed to the insulative body and partially exposed to the second mating surface, the plurality of second conductive terminals comprise at least one second high frequency signal conductive terminal, a contacting region of the second high frequency signal conductive terminal and a contacting region of the adjacent second conductive terminal are provided therebetween with a second impedance adjusting portion; and a middle isolating plate fixed to the insulative body and provided between the plurality of first conductive terminals and the plurality of second conductive terminals, a position of the middle isolating plate which corresponds to the first high frequency signal conductive terminal and the second high frequency signal conductive terminal is provided with a signal shielding portion.

In some embodiments, in the first direction, a length of the first impedance adjusting portion is larger than or equal to a length of the contacting region of the first high frequency signal conductive terminal, a length of the second impedance adjusting portion is larger than or equal to a length of the contacting region of the second high frequency signal conductive terminal.

In some embodiments, in a third direction, two sides of the first impedance adjusting portion respectively reach sides of the two adjacent first conductive terminals, two sides of the second impedance adjusting portion respectively reach sides of the two adjacent second conductive terminal, the first direction, the second direction and the third direction are perpendicular to each other.

In some embodiments, the first high frequency signal conductive terminal comprises a soldering portion, a second end portion, a middle portion and a first end portion which extend and are arranged along the first direction, a width of the middle portion is less than a width of the first end portion and a width of the second end portion, a width of the soldering portion is less than the width of the second end portion; the second high frequency signal conductive terminal comprises a soldering portion, a second end portion, a middle portion and a first end portion which extend and are arranged along the first direction, a width of the middle portion is less than a width of the first end portion and a width of the second end portion, a width of the soldering portion is less than the width of the second end portion.

In some embodiments, a projection of the first high frequency signal conductive terminal onto the middle isolating plate and a projection of the second high frequency signal conductive terminal onto the middle isolating plate respectively fall within a range of the signal shielding portion.

In some embodiments, in the first direction, a front side of the middle isolating plate protrudes forwardly relative to the plurality of first conductive terminals and the plurality of second conductive terminals.

In some embodiments, the insulative body comprises a first insulator, a second insulator and a cladding insulator, the first insulator and the first conductive terminal are integrally formed as a first combined member, the second insulator and the second conductive terminal are integrally formed as a second combined member, the middle isolating plate is provided between the first combined member and the second combined member and the middle isolating plate, the first combined member and the second combined member form a third combined member, the cladding insulator engages with the third combined member by insert molding process.

In some embodiments, the first impedance adjusting portion is a first recessed groove formed to the first insulator, the first recessed groove is recessed from a side surface of the first insulator away from the second insulator toward a direction close to the second insulator, the second impedance adjusting portion is a second recessed groove formed to the second insulator, the second recessed groove is recessed from a side surface of the second insulator away from the first insulator toward a direction close to the first insulator.

In some embodiments, the first impedance adjusting portion is a first through hole formed to the first insulator, the first through hole extends along the side surface of the first insulator away from the second insulator toward the direction close to the second insulator; the second impedance adjusting portion is a second through hole formed to the second insulator, the second through hole extends along the side surface of the second insulator away from the first insulator toward the direction close to the first insulator.

In some embodiments, two sides of a rear end of the middle isolating plate each are provided with a first elastic arm, the first elastic arms are elastically connected with inner sides of the shell.

In some embodiments, a front side and a rear side of the middle isolating plate each are a closed structure.

In some embodiments, a rear end of an upper surface of the shell is provided with a first stopping portion, the first stopping portion is recessed inwardly from the shell, when the insulative body is mounted inside the shell, the insulative body is stopped by the first stopping portion and a bottom plate of the shell.

In some embodiments, a bottom surface of the insulative body is provided with a cooperating portion, when the insulative body is mounted inside the shell, the cooperating portion and the bottom plate of the shell abut against each other.

The electrical connector provided by the present disclosure has following advantages: in the present disclosure, the first high frequency signal conductive terminal and the adjacent first conductive terminal of the electrical connector are provided therebetween with the first impedance adjusting portion, the second high frequency signal conductive terminal and the adjacent second conductive terminal of the electrical connector are provided therebetween with the second impedance adjusting portion, the middle isolating plate cooperates therewith, the characteristic impedances in the transmission process more match with high frequency transmission requirement, so that high frequency performance is improved, high frequency transmission effect is promoted, the structure is simple, it is convenient to be assembled, and cost is lowered.

### BRIEF DESCRIPTION OF THE DRAWINGS

Other features, objects, and advantages of the present disclosure will become more apparent by reviewing the detailed description on non-limiting embodiments with reference to the accompanying drawings.

FIG. 1 and FIG. 2 are structure schematic views of an electrical connector of an embodiment of the present disclosure;

FIG. 3 is a bottom view of an insulative body, a middle isolating plate and conductive terminals, which are assembled, of an embodiment of the present disclosure;

FIG. 4 is a top view of the insulative body, the middle isolating plate and the conductive terminals, which are assembled, of the embodiment of the present disclosure;

FIG. 5 is a bottom view of the electrical connector of the embodiment of the present disclosure;

FIG. 6 is a cross sectional view taken along a line A-A of FIG. 5;

FIG. 7 is an enlarged view of a part B of FIG. 6;

FIG. 8 is a schematic view of a conductive terminal and a middle isolating plate of an embodiment of the present disclosure;

FIG. 9 is a schematic view of an insulative body of an embodiment of the present disclosure;

FIG. 10 is a schematic view of a first conductive terminal of an embodiment of the present disclosure;

FIG. 11 is a schematic view of a first insulator of an embodiment of the present disclosure;

FIG. 12 is a schematic view of the first insulator of the embodiment of the present disclosure from another angle;

FIG. 13 is a schematic view that a first conductive terminal and a first insulator of an embodiment of the present disclosure cooperate with each other;

FIG. 14 is a schematic view of a second conductive terminal of an embodiment of the present disclosure;

FIG. 15 is a schematic view that a second conductive terminal and a second insulator of an embodiment of the present disclosure cooperate with each other;

FIG. 16 is a schematic view a middle isolating plate of an embodiment of the present disclosure;

FIG. 17 is a characteristic impedance schematic diagram of high frequency signal conductive terminals of an existing technology electrical connector measured with high frequency simulation analysis; and

FIG. 18 is a characteristic impedance schematic diagram of high frequency signal conductive terminals of the electrical connector of the present disclosure measured with high frequency simulation analysis.

### DETAILED DESCRIPTION

The example implementations will now be described more comprehensively with reference to the accompanying drawings. However, the example embodiments can be implemented in various forms and should not be understood as limited to the implementations described herein; on the contrary, providing these implementations makes that the present disclosure will be comprehensive and complete, and fully conveys the concept of the example implementations to those skilled in the art. The same reference numerals in the figures indicate the same or similar structures, so repeated descriptions thereof will be omitted. “Or” in the description may indicate “and” or “or”. Although the terms “up”, “down”, “between”, etc. may be used in the description to describe different exemplary features and elements of the present disclosure, these terms are used only for convenience herein, for example, are based on the example directions in the accompanying drawings. Any content of the description should not be understood that a specific three-dimensional orientation of the structure is required to be fallen within the scope of the present disclosure. Although the terms “first” or “second” are used in the description to represent certain features, they are only intended for indication and do not serve as limitations on the number and importance of the specific features.

In the embodiment illustrated in the drawings, a first direction refers to an x direction in FIG. 2, i.e. a direction extending from rear to front, a second direction refers to a y direction in FIG. 2, i.e. an up-down direction, a third direction refers to a z direction in FIG. 2, i.e. a left-right direction. The first direction, the second direction and the third direction are perpendicular to each other.

FIG. 17 is a characteristic impedance schematic diagram of two pairs of first high frequency signal conductive terminals and two pairs of second high frequency signal conductive terminals of an existing technology electrical connector measured with high frequency (for example 40 Gbps) simulation analysis, it can be seen that, characteristic impedances of the two pairs of first high frequency signal conductive terminals at contacting regions (a, b) are less than 76 Ohm, characteristic impedances of the two pairs of second high frequency signal conductive terminals at contacting regions (c, d) are about 94 Ohm. If higher transmission speed, for example 40 Gbps, requirement is met, the characteristic impedances need to be between 76 Ohm and 94 Ohm, however the high frequency signal conductive terminals of the existing electrical connector cannot all meet the above requirement.

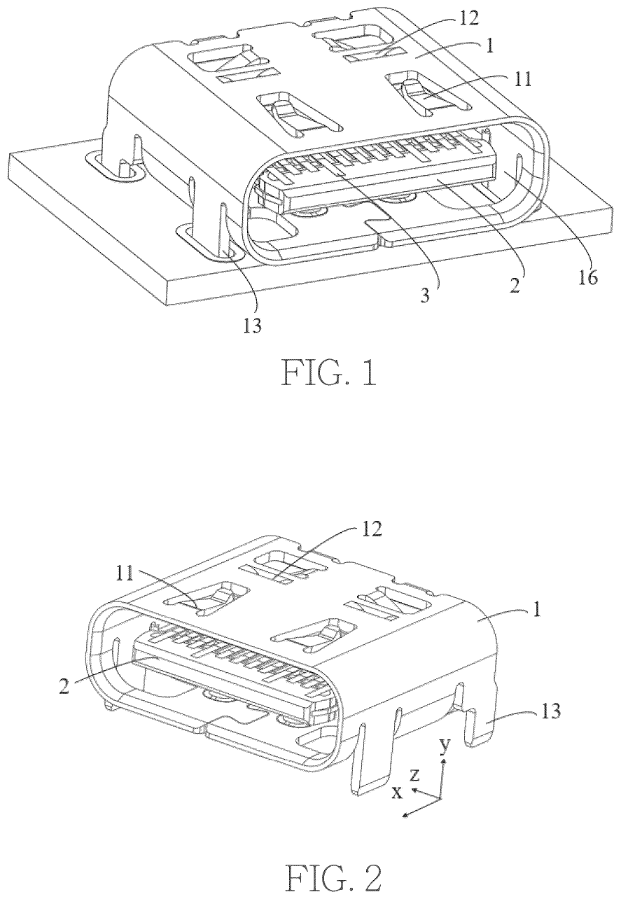

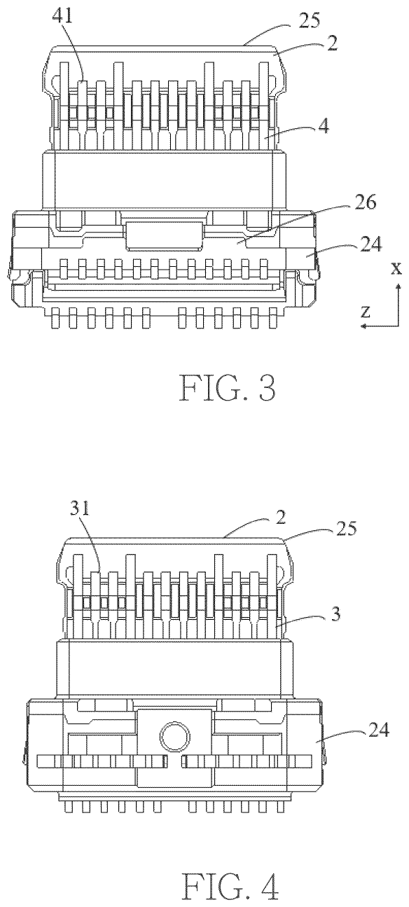

As shown in FIGS. 1-4, an embodiment of the present disclosure provides an electrical connector including a shell 1 and an insulative body 2, a middle isolating plate 5, a plurality of first conductive terminals 3 and a plurality of second conductive terminals 4 which are positioned in the shell 1, an upper surface of the shell 1 is provided with two second elastic arms 11. The shell 1 is a full shielding structure, grounded via four shell soldering legs 13 to reduce signal interference. The insulative body 2 entirely is a plastic member, the insulative body 2 includes a base 24 and a tongue 25 extending forwardly from the base 24, the tongue 25 includes a first mating surface (i.e. an upper surface under a view angel of FIG. 2) and a second mating surface (i.e. a lower surface under the view angle of FIG. 2) which are oppositely provided along the up-down direction. The shell 1 encircles the tongue 25 to form a mating cavity 16, a front end of the mating cavity 16 has an opening. The plurality of first conductive terminals 3 are fixed to the insulative body 2 and are partially exposed to the first mating surface. The plurality of first conductive terminals 3 include at least one first high frequency signal conductive terminal 31. The plurality of second conductive terminals 4 are fixed to the insulative body 2 and are partially exposed to the second mating surface, the plurality of second conductive terminals 4 include at least one second high frequency signal conductive terminal 41.

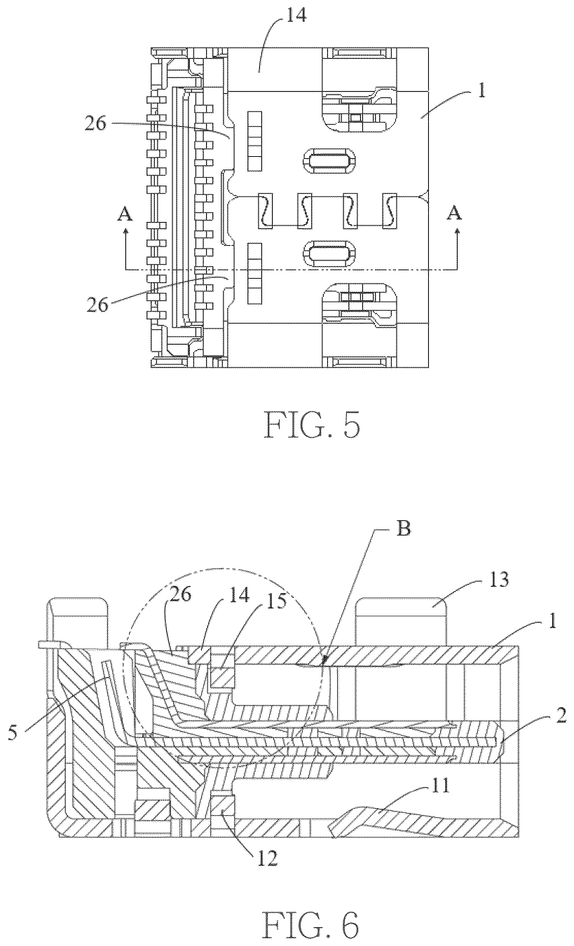

As shown in FIGS. 5-9, the middle isolating plate 5 is fixed to the insulative body 2 and is positioned between the plurality of first conductive terminals 3 and the plurality of second conductive terminals 4, a front side of the middle isolating plate 5 protrudes forwardly relative to the plurality of first conductive terminals 3 and the plurality of second conductive terminals 4. The insulative body 2 includes a first insulator 21, a second insulator 22 and a cladding insulator 23, the cladding insulator 23 partially clads a front side of the first insulator 21 and a front side of the second insulator 22, and the cladding insulator 23 partially clads the middle isolating plate 5. Specifically, a center of the cladding insulator 23 is provided with a long groove which is flat-plate shaped, the front side of the middle isolating plate 5 inserts into the long groove.

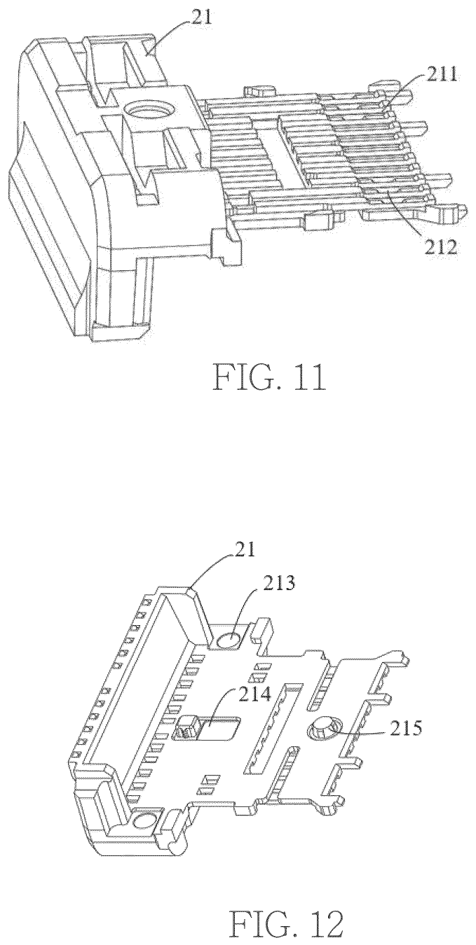

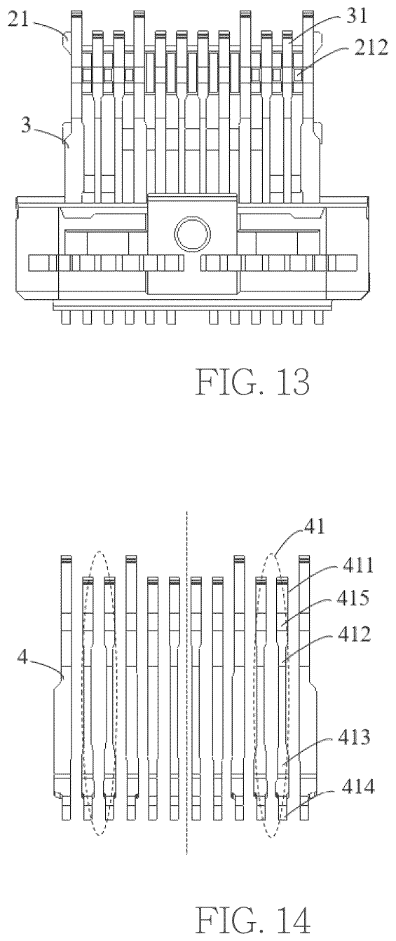

As shown in FIGS. 10-13, the first insulator 21 is provided with a plurality of first terminal receiving grooves 211 which are used to receive the plurality of first conductive terminals 3 respectively, the first insulator 21 is a plastic member, and the first insulator 21 and the plurality of first conductive terminals 3 may be selected to be integrally formed to form a first combined member, i.e. the plurality of first conductive terminals 3 are embedded in the plurality of first terminal receiving grooves 211 respectively, the plurality of first conductive terminals 3 and the first insulator 21 constitute the first combined member by for example insert molding process. The plurality of first conductive terminals 3 are symmetrically provided with respect to a dotted straight line of FIG. 10. A contacting region 315 of the first high frequency signal conductive terminal 31 and a contacting region of the adjacent first conductive terminal 3 are provided therebetween with a first impedance adjusting portion 212. In the embodiment, the first impedance adjusting portion 212 is a first recessed groove formed to an upper surface of the first insulator 21, in the second direction, the first recessed groove is recessed from the upper surface of the first insulator 21 (i.e., a side surface away from the second insulator 22) toward a direction close to the second insulator 22. In another embodiment, the first impedance adjusting portion 212 also may be a first through hole formed to the first insulator 21, the first through hole penetrates the upper surface and a lower surface of the first insulator 21, i.e. the first through hole extends along a side surface of the first insulator 21 away from the second insulator 22 toward a direction close to the second insulator 22.

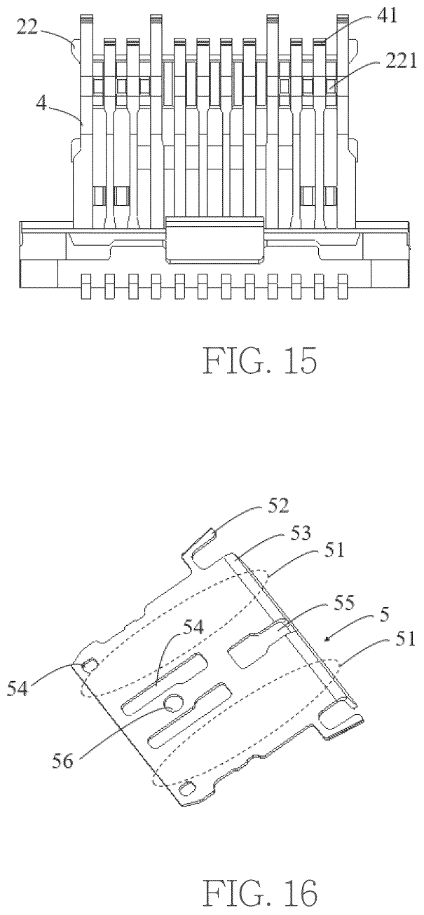

As shown in FIG. 14 and FIG. 15, the second insulator 22 is provided with a plurality of second terminal receiving grooves (not shown) which are used to receive the plurality of second conductive terminals 4 respectively, the second insulator 22 is a plastic member, and the second insulator 22 and the plurality of second conductive terminals 4 may be selected to be integrally formed as a second combined member, i.e. the plurality of second conductive terminals 4 are embedded in the plurality of second terminal receiving grooves respectively, the plurality of second conductive terminals 4 and the second insulator 22 constitute a second combined member by insert molding process. The plurality of second conductive terminals 4 are symmetrically provided with respect to a dotted straight line of FIG. 14. A contacting region 415 of the second high frequency signal conductive terminal 41 and a contacting region of the adjacent second conductive terminal 4 are provided therebetween with a second impedance adjusting portion 221. In the embodiment, the second impedance adjusting portion 221 is a second recessed groove formed to a lower surface of the second insulator 22, i.e. in the second direction, the second recessed groove is recessed from the lower surface of the second insulator 22 (i.e., a side surface away from the first insulator 21) toward a direction close to the first insulator 21. In another embodiment, the second impedance adjusting portion 221 also may be a second through hole formed to the second insulator 22, i.e. penetrating an upper surface and the lower surface of the second insulator 22, i.e. the second through hole extends along a side surface of the second insulator 22 away from the first insulator 21 toward a direction close to the first insulator 21.

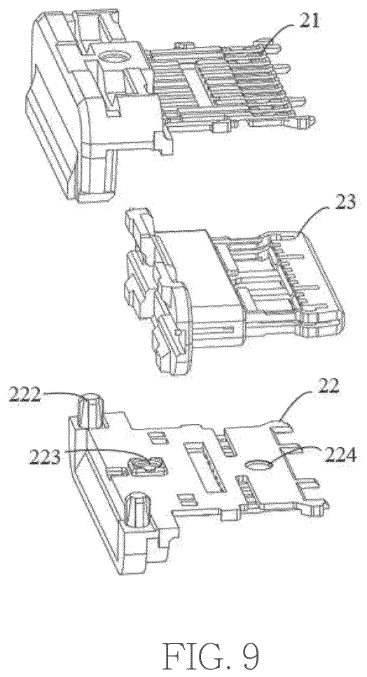

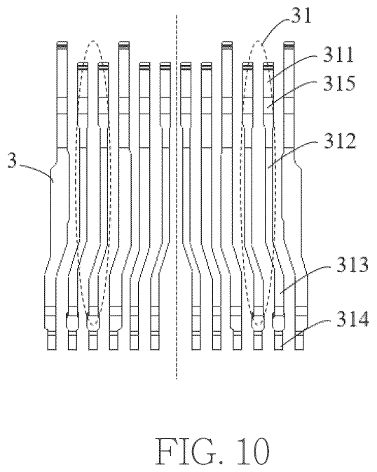

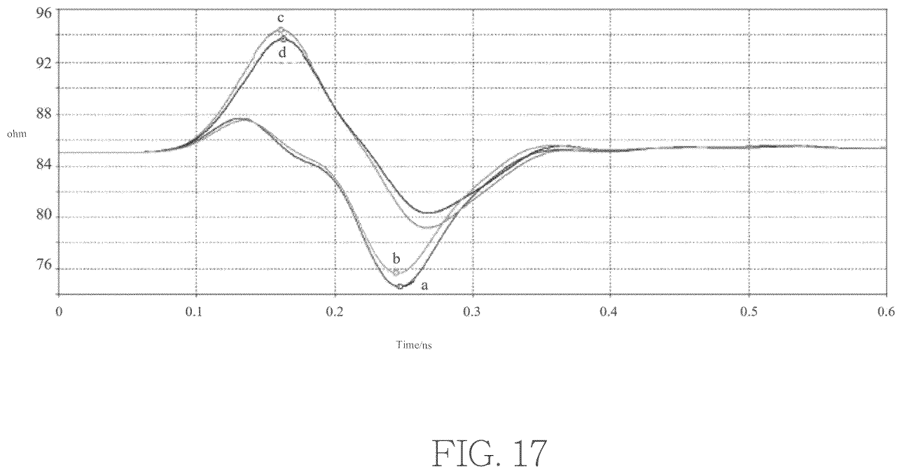

As shown in FIG. 8 and FIG. 16, the middle isolating plate 5 includes at least one signal shielding portion 51, the signal shielding portion 51 is a closed plate-shaped structure which is not provided with a hollow, realizes shielding between a signal of the first high frequency signal conductive terminal 31 positioned in the up and a signal of the second high frequency signal conductive terminal 41, and avoids interference between the signals. In the second direction, a position of the signal shielding portion 51 faces the first conductive terminal 3 and the second conductive terminal 4. A projection of the first high frequency signal conductive terminal 31 onto the middle isolating plate 5 and a projection of the second high frequency signal conductive terminal 41 onto the middle isolating plate 5 respectively fall within a range of the signal shielding portion 51. The middle isolating plate 5 is provided with at least one hollow portion 54, in a process of insert molding, by that the hollow portion 54 is filled by the insulative body 2, engagement between the insulative body 2 and the middle isolating plate 5 may be tighter. In the embodiment, the middle isolating plate 5, the first insulator 21 embedded with the plurality of first conductive terminals 3 (the first combined member) and the second insulator 22 embedded with the plurality of second conductive terminals 4 (the second combined member) are connected by inserting cooperation, and then are engaged as an integral structure (a third combined member) by insert molding process. Specifically, as shown in FIG. 16, the middle isolating plate 5 is provided with at least one first positioning hole 55 and second positioning hole 56, as shown in FIG. 12, the first insulator 21 includes a first positioning portion 213, a second positioning portion 214 and a third positioning portion 215, the first positioning portion 213 and the second positioning portion 214 are recessed grooves, the third positioning portion 215 is a protrusion. As shown in FIG. 9, the second insulator 22 is provided with a fourth positioning portion 222, a fifth positioning portion 223 and a sixth positioning portion 224, the fourth positioning portion 222 is a post, the fifth positioning portion 223 is a protrusion, the sixth positioning portion 224 is a recessed groove. The fourth positioning portion 222 inserts into the first positioning portion 213, the fifth positioning portion 223 passes through the first positioning hole 55 and inserts into the second positioning portion 214, the third positioning portion 215 passes through the second positioning hole 56 and inserts into the sixth positioning portion 224, so that the first insulator 21, the middle isolating plate 5 and the second insulator 22 form a sandwich structure which is stably connected.

When the electrical connector are assembled, the middle isolating plate 5 is provided between the first insulator 21 embedded with the plurality of first conductive terminals 3 and the second insulator 22 embedded with the plurality of second conductive terminals 4, then the first insulator 21 embedded with the plurality of first conductive terminals 3 (the first combined member), the middle isolating plate 5 and the second insulator 22 embedded with the plurality of second conductive terminals 4 (the second combined member) are assembled to be a sandwich structure (the third combined member), next by insert molding process, the cladding insulator 23 is engaged onto the sandwich structure, subsequently the cladding insulator 23 and the sandwich structure are entirely put into the shell 1, the electrical connector is simple in structure and is convenient to be assembled.

By employing the design of the present disclosure, the first high frequency signal conductive terminal 31 and the adjacent first conductive terminal 3 of the electrical connector are provided therebetween with the first impedance adjusting portion 212, the second high frequency signal conductive terminal 41 and the adjacent second conductive terminal 4 of the electrical connector are provided therebetween with the second impedance adjusting portion 221, and the signal shielding portion 51 of the middle isolating plate 5 cooperate therewith, characteristic impedances of the conductive terminals more match with high frequency transmission requirement, so that high frequency performance is improved, high frequency transmission effect is promoted, higher data transmission speed is attained.

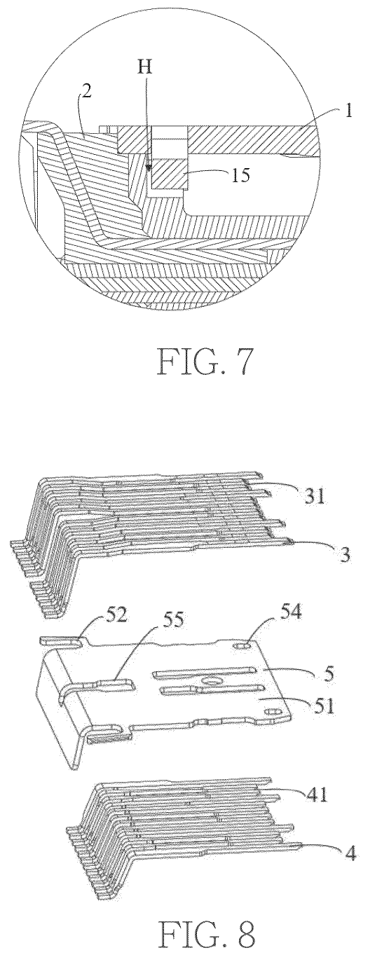

In combination with FIG. 1, FIG. 2, FIG. 6 and FIG. 7, a rear end of the upper surface of the shell 1 is provided with a first stopping portion 12, the first stopping portion 12 is recessed inwardly relative to the upper surface of the shell 1, a bottom surface of the insulative body 2 is provided with a cooperating portion 26, a bottom plate 14 of the shell 1 and the cooperating portion 26 abut against each other, by that cooperation of the first stopping portion 12 and the bottom plate 14 of the shell 1, the assembled structure of the insulative body 2 and the conductive terminals is retained at a middle position inside the shell 1. The existing technology performs stopping by the first stopping portion 12 and a second stopping portion 15 which are symmetrically provided to an upper surface and a lower surface of the shell, the requirement on symmetric position precision of the first stopping portion and the second stopping portion is very high, the present disclosure performs stopping by cooperation of the first stopping portion 12 positioned to the upper surface of the shell 1 and the bottom plate 14 of the shell 1 (as shown in FIG. 7, the second stopping portion 15 and the insulative body 2 have a gap H therebetween, the second stopping portion 15 does not function as positioning), which may lower the requirement on dimensions and position precisions of the stopping portions, avoid position offset occurring when the electrical connector is assembled, yield of the electrical connector is promoted. And the electrical connector omits the internal shielding metal shell between the insulative body 2 and the shell 1 in the existing connector, the number and soldering processes of components are reduced, cost is lowered.

In a preferred embodiment, in the first direction, a length of the first impedance adjusting portion 212 is larger than or equal to a length of the contacting region 315 of the first high frequency signal conductive terminal 31. Optionally, in the third direction, two sides of the first impedance adjusting portion 212 respectively reach sides of the two adjacent first conductive terminals 3, which may increase the improvement effect of the first impedance adjusting portion 212. The first high frequency signal conductive terminal 31 includes a soldering portion 314, a second end portion 313, a middle portion 312 and a first end portion 311 which sequentially forwardly extend and are arranged, a width of the middle portion 312 is less than a width of the first end portion 311 and a width of the second end portion 313, a width of the soldering portion 314 is less than the width of the second end portion 313.

In a preferred embodiment, in the first direction, a length of the second impedance adjusting portion 221 is larger than or equal to a length of the contacting region 415 of the second high frequency signal conductive terminal 41. Optionally, in the third direction, two sides of the second impedance adjusting portion 221 respectively reach sides of the two adjacent second conductive terminals 4, which may increase the improvement effect of the second impedance adjusting portion 221. The second high frequency signal conductive terminal 41 includes a soldering portion 414, a second end portion 413, a middle portion 412 and a first end portion 411 which sequentially forwardly extend and are arranged, a width of the middle portion 412 is less than a width of the first end portion 411 and a width of the second end portion 413, a width of the soldering portion 414 is less than the width of the second end portion 413.

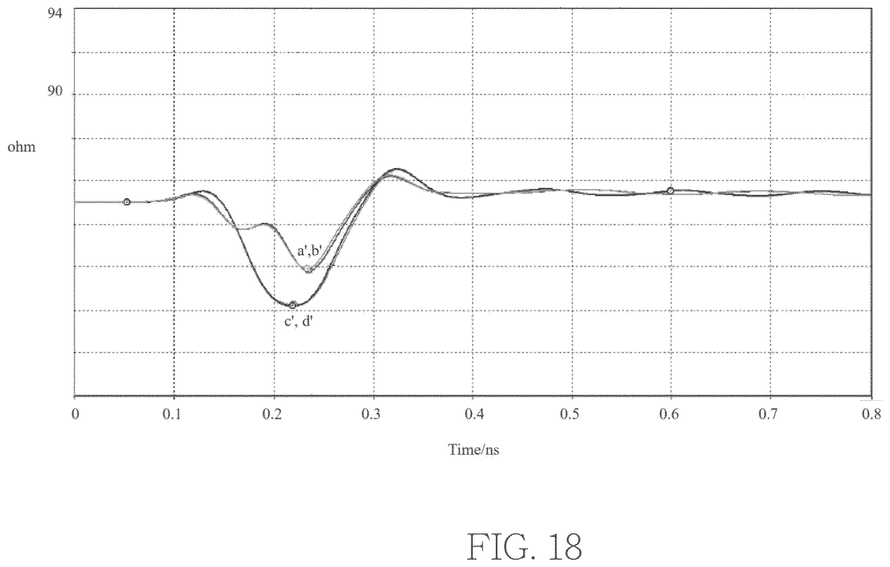

FIG. 18 is a characteristic impedance schematic diagram of two pairs of first high frequency signal conductive terminals and two pairs of second high frequency signal conductive terminals of the electrical connector of the present disclosure measured by high frequency (for example 40 Gbps) simulation analysis, it can be seen that, characteristic impedances of the two pairs of first high frequency signal conductive terminals which almost coincide are about 82 Ohm at the contacting regions (a′, b′), characteristic impedances of the two pairs of second high frequency signal conductive terminals which almost coincide are about 80 Ohm at the contacting regions (c′, d′), the characteristic impedances of the four pairs of high frequency signal conductive terminals all are between 76 Ohm and 94 Ohm, which meets the requirement of higher transmission speed.

As shown in FIG. 16, two sides of a rear end of the middle isolating plate 5 each are provided with a first elastic arm 52, the first elastic arms 52 are elastically connected with inner sides of the shell 1. A rear side of the middle isolating plate 5 is formed as a bent portion 53, and the front side and the rear side of the middle isolating plate 5 each are a closed structure which is not provided with a hollow. The middle isolating plate 5 and the shell 1 are conductive metal materials, realize entire shielding of a periphery of the electrical connector, and avoid crosstalk and interference between high frequency signals. The fourth positioning portion 222 of the second insulator 22 (shown in FIG. 9) may passes through a gap between the first elastic arm 52 of the middle isolating plate 5 and a main body of the middle isolating plate 5 and then insert into the first positioning portion 213 of the first insulator 21 (shown in FIG. 12). The middle isolating plate 5 omits a soldering leg SMT of the existing technology, reduces the number of the SMT soldering legs which are coplanar, is beneficial to promote yield of the product and lowers cost. In conclusion, in the present disclosure, the first high frequency signal conductive terminal and the adjacent first conductive terminal of the electrical connector are provided therebetween with the first impedance adjusting portion, the second high frequency signal conductive terminal and the adjacent second conductive terminal of the electrical connector are provided therebetween with the second impedance adjusting portion, the characteristic impedances of the conductive terminals more match with high frequency transmission requirement, so that high frequency performance is improved; by that a position of the middle isolating plate corresponding to the high frequency signal conductive terminals is provided with the closed signal shielding portion to perform shielding on the high frequency signals positioned to the up and the down, interference and crosstalk between the signals are avoided, so that high frequency transmission effect is efficiently promoted; at the same time in combination with that the widths of the different portions of the respective high frequency signal conductive terminals are different, loss in high frequency transmission process is reduced, high frequency transmission requirement is further matched. The electrical connector reduces the number of the components, is simple in entire structure, is convenient to be assembled, lowers requirement on precision of manufacturing process, avoids position offset between the components when assembled, efficiently promotes yield, and greatly lower cost.

The above content is a further detailed description of the present disclosure based on specific preferred embodiments, and it cannot be considered that the specific implementation of the present disclosure is limited to these descriptions. For ordinary technical personnel in the technical field to which this application belongs, without departing from the concept of the present disclosure, several simple deductions or substitutions can be made, which should be considered as within the scope of protection of the present disclosure.

What is claimed is:

1. An electrical connector, comprising:
a shell;
an insulative body mounted inside the shell, the insulative body comprising a base and a tongue which extends from the base along a first direction, the tongue comprising a first mating surface and a second mating surface which are oppositely provided along a second direction, and the shell encircling the tongue to form a mating cavity;
a plurality of first conductive terminals fixed to the insulative body and partially exposed to the first mating surface, the plurality of first conductive terminals comprising at least one first high frequency signal conductive terminal, a contacting region of the first high frequency signal conductive terminal and a contacting region of the adjacent first conductive terminal being provided therebetween with a first impedance adjusting portion;
a plurality of second conductive terminals fixed to the insulative body and partially exposed to the second mating surface, the plurality of second conductive terminals comprising at least one second high frequency signal conductive terminal, a contacting region of the second high frequency signal conductive terminal and a contacting region of the adjacent second conductive terminal being provided therebetween with a second impedance adjusting portion; and
a middle isolating plate fixed to the insulative body and provided between the plurality of first conductive terminals and the plurality of second conductive terminals, a position of the middle isolating plate which corresponds to the first high frequency signal conductive terminal and the second high frequency signal conductive terminal being provided with a signal shielding portion.

2. The electrical connector according to claim 1, wherein
in the first direction, a length of the first impedance adjusting portion is larger than or equal to a length of the contacting region of the first high frequency signal conductive terminal, a length of the second impedance adjusting portion is larger than or equal to a length of the contacting region of the second high frequency signal conductive terminal.

3. The electrical connector according to claim 1, wherein
in a third direction, two sides of the first impedance adjusting portion respectively reach sides of the two adjacent first conductive terminals, two sides of the second impedance adjusting portion respectively reach sides of the two adjacent second conductive terminal,
the first direction, the second direction and the third direction are perpendicular to each other.

4. The electrical connector according to claim 1, wherein
the first high frequency signal conductive terminal comprises a soldering portion, a second end portion, a middle portion and a first end portion which extend and are arranged along the first direction, a width of the middle portion is less than a width of the first end portion and a width of the second end portion, a width of the soldering portion is less than the width of the second end portion;
the second high frequency signal conductive terminal comprises a soldering portion, a second end portion, a middle portion and a first end portion which extend and are arranged along the first direction, a width of the middle portion is less than a width of the first end portion and a width of the second end portion, a width of the soldering portion is less than the width of the second end portion.

5. The electrical connector according to claim 1, wherein
a projection of the first high frequency signal conductive terminal onto the middle isolating plate and a projection of the second high frequency signal conductive terminal onto the middle isolating plate respectively fall within a range of the signal shielding portion.

6. The electrical connector according to claim 1, wherein
in the first direction, a front side of the middle isolating plate protrudes forwardly relative to the plurality of first conductive terminals and the plurality of second conductive terminals.

7. The electrical connector according to claim 1, wherein
the insulative body comprises a first insulator, a second insulator and a cladding insulator,
the first insulator and the first conductive terminal are integrally formed as a first combined member,
the second insulator and the second conductive terminal are integrally formed as a second combined member,
the middle isolating plate is provided between the first combined member and the second combined member and the middle isolating plate, the first combined member and the second combined member form a third combined member,
the cladding insulator engages with the third combined member by insert molding process.

8. The electrical connector according to claim 7, wherein
the first impedance adjusting portion is a first recessed groove formed to the first insulator, the first recessed groove is recessed from a side surface of the first insulator away from the second insulator toward a direction close to the second insulator,
the second impedance adjusting portion is a second recessed groove formed to the second insulator, the second recessed groove is recessed from a side surface of the second insulator away from the first insulator toward a direction close to the first insulator.

9. The electrical connector according to claim 7, wherein
the first impedance adjusting portion is a first through hole formed to the first insulator, the first through hole extends along the side surface of the first insulator away from the second insulator toward the direction close to the second insulator;
the second impedance adjusting portion is a second through hole formed to the second insulator, the second through hole extends along the side surface of the second insulator away from the first insulator toward the direction close to the first insulator.

10. The electrical connector according to claim 1, wherein
two sides of a rear end of the middle isolating plate each are provided with a first elastic arm, the first elastic arms are elastically connected with inner sides of the shell.

11. The electrical connector according to claim 1, wherein
a front side and a rear side of the middle isolating plate each are a closed structure.

12. The electrical connector according to claim 1, wherein
a rear end of an upper surface of the shell is provided with a first stopping portion, the first stopping portion is recessed inwardly from the shell,
when the insulative body is mounted inside the shell, the insulative body is stopped by the first stopping portion and a bottom plate of the shell.

13. The electrical connector according to claim 12, wherein
a bottom surface of the insulative body is provided with a cooperating portion,
when the insulative body is mounted inside the shell, the cooperating portion and the bottom plate of the shell abut against each other.
